(19) United States
(12) Patent Application Publication
(10) Pub. No.: US 2022/0397933 A1
(43) Pub. Date: Dec. 15, 2022

(54) COMPUTING DEVICE MECHANISMS

(71) Applicant: Hewlett-Packard Development Company, L.P., Spring, TX (US)

(72) Inventors: Dong Ryul Cha, Spring, TX (US); Mark Senatori, Spring, TX (US); Ilchan Lee, Spring, TX (US)

(73) Assignee: Hewlett-Packard Development Company, L.P., Spring, TX (US)

(21) Appl. No.: 17/419,753

(22) PCT Filed: Aug. 29, 2019
(86) PCT No.: PCT/US2019/048807

§ 371 Date: Jun. 30, 2021

(51) Int. Cl. G06F 1/16

(52) U.S. Cl. CPC G06F 1/166; G06F 1/1681; G06F 1/1616

(57) ABSTRACT

An example computing device includes a hinge, a first housing, and a second housing rotatably connected to the first housing via the hinge. As an example, a first display device is disposed in the first housing. The second housing includes a cover disposed along a bottom surface of the second housing, wherein the cover includes a first portion and a second portion separable from the first portion of the cover. As an example, the second portion of the cover includes an L-shaped mechanism coupled to the first portion of the cover at a first end of the L-shaped mechanism and to the first housing at a second end of the L-shaped mechanism.

### BACKGROUND

The emergence and popularity of mobile computing has made portable computing devices, due to their compact design and light weight, a staple in today's marketplace. Within the mobile computing realm, notebook computers, or laptops, are one of the more widely used devices and generally employ a clamshell-type design consisting of two housings connected together at a common end via hinges, for example. In most cases, a first housing or display member is utilized to provide a viewable display to a user while a second housing or base member includes an area for user input (e.g., touchpad and keyboard). In addition, the viewable display may be a touchscreen (e.g., touchscreen laptop), allowing the user to interact directly with what is displayed by touching the screen with simple or multi-touch gestures.

### BRIEF DESCRIPTION OF THE DRAWINGS

FIGS. 1A-B illustrate a computing device that includes a mechanism for elevating the computing device while it is in use, according to an example;

FIGS. 2A-C illustrate side views of the computing device as the first housing is rotated open, according to an example; and

FIGS. 3A-C illustrate side views of another computing device as the first housing is rotated open, according to an example.

### DETAILED DESCRIPTION

Examples disclosed herein provide a mechanism for computing devices, such as the notebook computer described above, for improving the thermal performance of the computing devices, as heat generating components, such as a central processing unit (CPU), generate heat. As the demand for higher performing notebook computers continue to grow, more space and open areas may be required for thermal intake and exhaust, for example, in order to draw more cool air to the notebook computer. With the ability to draw in more cool air, the fan speed may also be decreased, resulting in reduction of noise generated by the notebook computer.

As will be further described, the mechanism for improving the thermal performance of the notebook computer may include an L-shaped mechanism linked to a bottom surface of the base member that elevates an end of the base member. By elevating an end of the base member while the notebook computer is in use, a vent along the bottom surface of the base member may be used to channel air to flow between the notebook computer and environment. In addition to improving the thermal performance of the notebook computer, the elevation provided by the L-shaped mechanism may provide an appropriate viewing angle for a secondary display, for example, disposed in the base member, as will be further described.

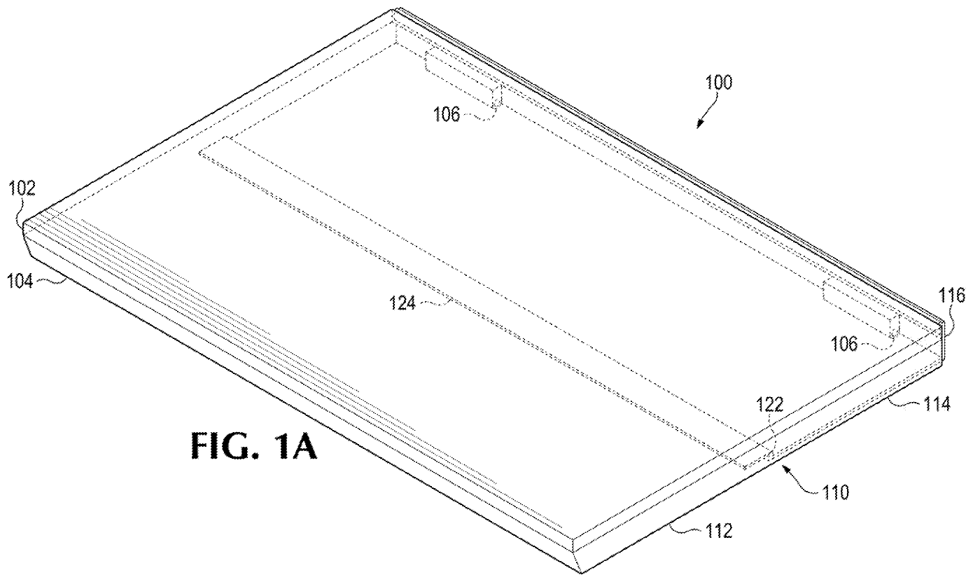

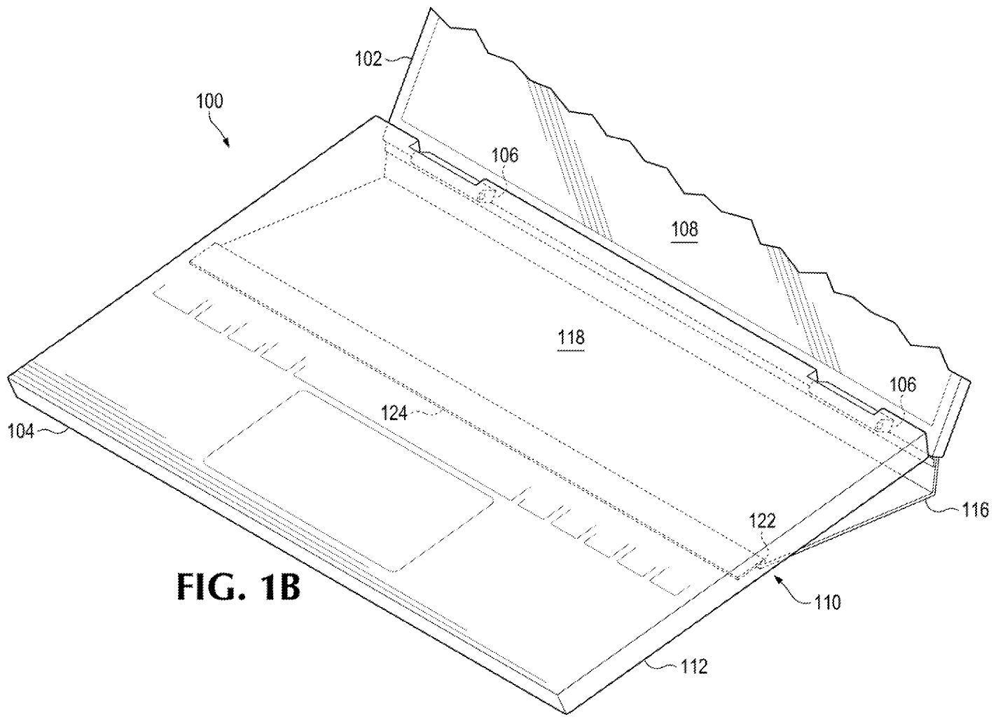

With reference to the figures, FIGS. 1A-B illustrate a computing device 100 that includes a mechanism for elevating the computing device 100 while it is in use, according to an example. As an example, the computing device 100 may correspond to a notebook computer, as described above. As illustrated, the computing device 100 includes a first housing 102 and a second housing 104 rotatably connected to the first housing 102, for example, via a hinge 106. Although two hinges 106 are illustrated, the arrangement of the hinge 106 may vary, in order to allow for the first and second housings 102, 104 to be rotatably connected to each other.

Referring to FIG. 1B, a display device 108 may be disposed in the first housing 102. As mentioned above, the display device 108 may be utilized to provide a viewable display to a user, in addition to allowing the user to interact directly with what is displayed by touching the display device 108 with simple or multi-touch gestures. The second housing 104 may include an area for user input (e.g., touchpad and keyboard), as illustrated. In addition, as will be further described, another display device (i.e., a second display device) may be disposed in the second housing 104 (not illustrated). By including a second display device in the second housing 104, the mechanism for elevating the computing device 100 while it is in use, may provide an appropriate viewing angle for the second display device.

As an example, the mechanism for elevating the computing device 100 may be disposed along a bottom surface 110 of the second housing 104 of the computing device 100, as part of a cover. The second housing 104 may include the cover disposed along the bottom surface 110, and the cover may include a first portion 112 and a second portion 114 separable from the first portion 112 of the cover, as will be further described. As an example, the second portion 114 may occupy a third of the cover, towards the back of the computing device 100, while the first portion 112 may occupy the remaining two-thirds. However, the ratio of the first and second portions 112, 114 may vary. For example, the second portion 114 may occupy greater or less than a third of the cover.

As an example of the mechanism for elevating the computing device 100, the second portion 114 of the cover includes an L-shaped mechanism 116. In addition to being disposed along the bottom surface 110 of the second housing 104 of the computing device 100, the L-shaped mechanism 116 may have a bend (e.g., the “L” shaped portion) that draws vertically up towards the first housing 102, along the rear of the computing device 100, as illustrated. The L-shaped mechanism 116 may be a solid piece, for example, formed, forged, stamped, or cut via a computer numerical control (CNC) router, using metal substrates, such as aluminum, stainless steel, or magnesium.

As an example, the L-shaped mechanism 116 may be linked to the first housing 102 and to the chassis of the computing device 100, as will be further described. For example, the L-shaped mechanism 116 may be coupled to the first portion 112 of the cover at a first end of the L-shaped mechanism 116, and to the first housing 102 at a second end of the L-shaped mechanism 116, for example, at the end of the L-shaped mechanism 116 that draws vertically up towards the first housing 102. As will be further described, as the first housing 102 is rotated opened, for example, when the computing device is in use, the L-shaped mechanism 116 moves or extends in unison, lifting the computing device 100, thereby creating an opening along the bottom surface 110 of the computing device 100, allowing for additional areas for thermal intake and exhaust.

Referring to FIG. 1B, in response to a rotation of the first housing 102 relative to the second housing 104, an angle of the second housing 104 with respect to a surface that the computing device 100 is disposed on, such as a table, is to change. For example, as the first housing 102 is opened from the second housing 104, associated movement of the L-shaped mechanism 116 is to elevate the angle, as illustrated in FIG. 1B, when the computing device 100 is likely in use. In addition to providing additional areas for thermal intake and exhaust, the elevated angle provided by the L-shaped mechanism 116 may provide an appropriate viewing angle for a second display device, for example, disposed in the second housing 104 (not illustrated), for example, along a rear section 118 of the second housing 104. As an example, as the first housing 102 is closed back towards the second housing 104, movement of the L-shaped mechanism 116 is to decrease the angle, as illustrated in FIG. 1A, when the computing device 100 is likely not in use.

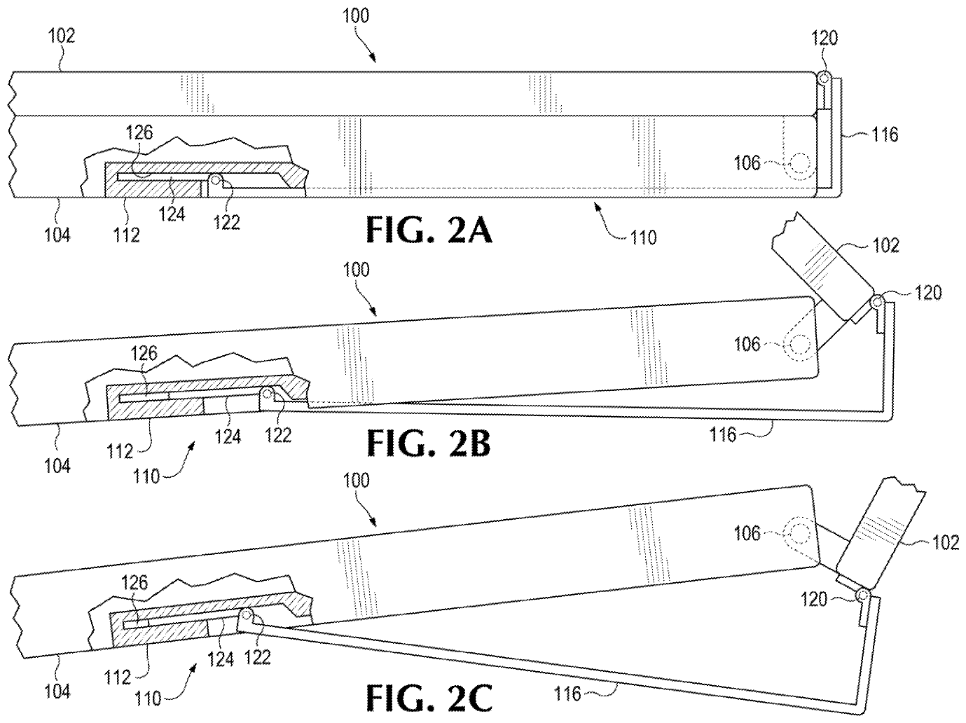

FIGS. 2A-C illustrate side views of the computing device 100 as the first housing 102 is rotated open, according to an example. As mentioned above, the L-shaped mechanism 116 may be coupled to the first portion 112 of the cover at a first end of the L-shaped mechanism 116, and to the first housing 102 at a second end of the L-shaped mechanism 116. The hardware used for coupling the L-shaped mechanism 116 to the computing device 100 may vary, as will be illustrated in the following figures. As an example, the hardware used for coupling the L-shaped mechanism 116 to the computing device 100 may exhibit very low or no friction, in order to allow for the L-shaped mechanism 116 to move freely as the first housing 102 is rotated opened or closed.

For example, referring to FIGS. 2A-C, the L-shaped mechanism 116 may be coupled to the computing device 100 via flexure bearings that offer low or no friction. Examples of such flexure bearings include, but are not limited to, a rod traversing an axis. For example, the L-shaped mechanism 116 may be coupled to the first housing 102 at 120. Similarly, the L-shaped mechanism 116 may be coupled to the first portion 112 of the cover at 122. As an example, an extension 124 to the L-shaped mechanism 116 may traverse a cavity 126 disposed in the first portion 112 of the cover as the first housing 102 is rotated opened and closed, as will be further described.

Referring to FIG. 2A, when the first housing 102 is closed upon the second housing 104, the L-shaped mechanism 116 remains flush along the bottom surface 110 of the computing device 100 and in contact with the first portion 112 of the cover disposed along the bottom surface 110. Referring to FIG. 2B, as the first housing 102 is rotated opened via hinge 106, a resulting movement at 120 and 122 may cause the L-shaped mechanism 116 to begin elevating the computing device 100, so that an angle of the second housing 104 with respect to a surface that the computing device 100 is disposed on is formed. As an example, the low or no friction provided at 120 and 122 allow for the L-shaped mechanism 116 to move in unison with the first housing 102 as it is rotated opened.

Finally, at FIG. 2C, with the first housing 102 fully opened, the L-shaped mechanism 116 fully elevates the computing device 100, providing the benefits mentioned above, such as thermal efficiency and an appropriate viewing angle for a secondary display that may be disposed in the second housing 104. Referring to FIGS. 2A-C, the extension 124 traverses the cavity 126 as the first housing 102 is rotated opened. As an example, the placement of the extension 124 within the cavity 126 may be dependent on first housing 102 as it is rotated. As an example, the extension 124 may be a sliding metal clasp that engages with the cavity 126, in order to provide a degree of tension, so that the L-shaped mechanism 116 remains in place while the computing device 100 is elevated.

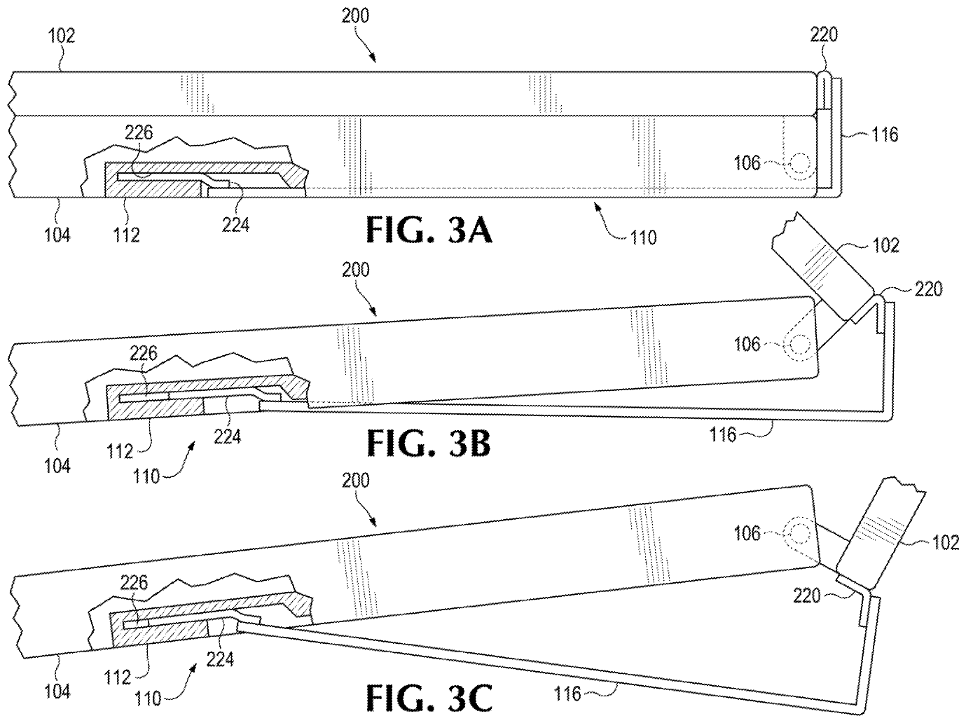

FIGS. 3A-C illustrate side views of a computing device 200 as the first housing 102 is rotated open, according to an example. Similar components, as those found in computing device 100 may share the same reference numerals. As an effort to exhibit low or no friction for the L-shaped mechanism 116 to move freely as the first housing 102 is rotated opened or closed, the L-shaped mechanism 116 may be coupled to the computing device 200 via connectors made from flexible material. As illustrated, the L-shaped mechanism 116 may be coupled to the first housing 102 via connector 220. Similarly, the L-shaped mechanism 116 may be coupled to the first portion 112 of the cover via connector 224. Similar to extension 124 of computing device 100, connector 224 may traverse a cavity 226 disposed in the first portion 112 of the cover as the first housing 102 is rotated opened and closed. In some examples, the connectors 220, 224 may be made from thermoplastic elastomer material, such as thermoplastic polyurethane or thermoplastic copolyester, thereby creating living hinges.

Referring to FIG. 3A, when the first housing 102 is closed upon the second housing 104, the L-shaped mechanism 116 remains flush along the bottom surface 110 of the computing device 200 and in contact with the first portion 112 of the cover disposed along the bottom surface 110. Referring to FIG. 3B, as the first housing 102 is rotated opened via hinge 106, connectors 220, 224 may cause the L-shaped mechanism 116 to begin elevating the computing device 200, so that an angle of the second housing 104 with respect to a surface that the computing device 200 is disposed on is formed. As an example, the low or no friction provided at connectors 220, 224 allow for the L-shaped mechanism 116 to move in unison with the first housing 102 as it is rotated opened. Finally, at FIG. 2C, with the first housing 102 fully opened, the L-shaped mechanism 116 fully elevates the computing device 200, providing the benefits mentioned above, such as thermal efficiency and an appropriate viewing angle for a secondary display that may be disposed in the second housing 104.

It is appreciated that examples described may include various components and features. It is also appreciated that numerous specific details are set forth to provide a thorough understanding of the examples. However, it is appreciated that the examples may be practiced without limitations to these specific details. In other instances, well known methods and structures may not be described in detail to avoid unnecessarily obscuring the description of the examples. Also, the examples may be used in combination with each other.

Reference in the specification to ‘an example’ or similar language means that a particular feature, structure, or characteristic described in connection with the example is included in at least one example, but not necessarily in other examples. The various instances of the phrase “in one example” or similar phrases in various places in the specification are not necessarily all referring to the same example.

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the scope of the disclosure. Thus, the present disclosure is not intended to be limited to the examples shown herein but is to be accorded the widest scope consistent with the principles and novel features disclosed herein.

What is claimed is:

1. A computing device comprising:
a hinge;
a first housing;
a first display device disposed in the first housing;
a second housing rotatably connected to the first housing via the hinge, wherein the second housing comprises a cover disposed along a bottom surface of the second housing, wherein the cover comprises a first portion and a second portion separable from the first portion of the cover; and
the second portion of the cover comprising an L-shaped mechanism coupled to the first portion of the cover at a first end of the L-shaped mechanism and to the first housing at a second end of the L-shaped mechanism, wherein, in response to a rotation of the first housing relative to the second housing, an angle of the second housing with respect to a surface that the computing device is disposed on is to change.

2. The computing device of claim 1, wherein, in response to the rotation of the first housing relative to the second housing, as the first housing is opened from the second housing, the L-shaped mechanism is to elevate the angle.

3. The computing device of claim 1, wherein, in response to the rotation of the first housing relative to the second housing, as the first housing is closed towards the second housing, the L-shaped mechanism is to decrease the angle.

4. The computing device of claim 1, further comprising a second display device disposed in the second housing.

5. The computing device of claim 1, wherein the L-shaped mechanism is coupled to the first portion of the cover and the first housing via flexure bearings.

6. The computing device of claim 5, wherein the L-shaped mechanism is coupled to the first portion of the cover via an extension that is to traverse a cavity disposed in the first portion of the cover, wherein the flexure bearing is coupled to the extension.

7. The computing device of claim 1, wherein the L-shaped mechanism is coupled to the first portion of the cover via a sliding metal clasp.

8. The computing device of claim 1, wherein the L-shaped mechanism is coupled to the first portion of the cover and the first housing via connectors made from flexible material.

9. A computing device comprising:
a hinge;
a first housing;
a first display device disposed in the first housing;
a second housing rotatably connected to the first housing via the hinge, wherein the second housing comprises a cover disposed along a bottom surface of the second housing, wherein the cover comprises a first portion and a second portion separable from the first portion of the cover; and
the second portion of the cover comprising an L-shaped mechanism coupled to the first portion of the cover at a first end of the L-shaped mechanism via a first connector made from flexible material, and coupled to the first housing at a second end of the L-shaped mechanism via a second connector made from flexible material.

10. The computing device of claim 9, wherein, in response to a rotation of the first housing relative to the second housing, an angle of the second housing with respect to a surface that the computing device is disposed on is to change.

11. The computing device of claim 10, wherein, in response to the rotation of the first housing relative to the second housing, as the first housing is opened from the second housing, the L-shaped mechanism is to elevate the angle.

12. The computing device of claim 9, wherein the flexible materials for the first and second connectors comprise thermoplastic elastomer material.

13. A computing device comprising:
a hinge;
a first housing;
a first display device disposed in the first housing;
a second housing rotatably connected to the first housing via the hinge, wherein the second housing comprises a cover disposed along a bottom surface of the second housing, wherein the cover comprises a first portion and a second portion separable from the first portion of the cover; and
the second portion of the cover comprising an L-shaped mechanism coupled to the first portion of the cover at a first end of the L-shaped mechanism via a first flexure bearing, and coupled to the first housing at a second end of the L-shaped mechanism via a second flexure bearing.

14. The computing device of claim 13, wherein the first and second flexure bearings comprise a rod traversing an axis.

15. The computing device of claim 13, wherein, in response to a rotation of the first housing relative to the second housing, as the first housing is opened from the second housing, the L-shaped mechanism is to elevate the angle.
